(19) United States
(12) Patent Application Publication
(10) Pub. No.: US 2012/0165003 A1
(43) Pub. Date: Jun. 28, 2012

(54) WIRELESS COMMUNICATIONS DEVICE

(75) Inventors: Colin Kellett, Wiltshire (GB); Antony Lee Morgan, Mid-Glamorgan (GB); Peter Keevill, Bath (GB); Keith Day, Pershore (GB)

(73) Assignee: UBIQUISYS LIMITED, Wiltshire (GB)

(21) Appl. No.: 13/152,629

(22) Filed: Jun. 3, 2011

(30) Foreign Application Priority Data
Dec. 23, 2010 (GB) 1021895.6

(51) Int. Cl. H04W 4/00

(52) U.S. Cl. 455/422.1

(57) ABSTRACT

A wireless access device is operable in a mode in which its maximum transmit power is set to a value that means that the device has a range of less than 1 metre. This allows the device to operate as a basestation in a cellular communications network, even in locations in which it is not specifically licensed, because the power level is so low that it will not cause interference on the licensed frequencies. The wireless access device is designed such that a handheld portable device can be maintained in a close spatial relationship to it.

This invention relates to a wireless communications device, and in particular to a device that allows a user to use their existing cellular phone in regions where there is no cellular phone coverage, at least for that particular model of phone, or where the user's cellular phone subscription would incur high charges.

Cellular phones operate by establishing a connection with a basestation that has a connection into a cellular network, managed by a mobile network operator. Each basestation has a respective coverage area, and the coverage areas can vary in size between areas having a diameter of several kilometres, in the case of macrocell basestations, and areas having a diameter of perhaps metres or tens of metres, in the case of femtocell basestations. The connection between the cellular phone and the basestation uses a cellular communications protocol, which allows for the possibility of handover, when the cellular phone moves between the coverage areas of different basestations, and which allows for several cellular phones to be connected to the basestation. Suitable cellular communications protocols include the GSM, IS-54, IS-95, IS-136, Universal Mobile Telecommunications System (UMTS), CDMA 2000, mobile WiMAX (Worldwide Interoperability for Microwave Access), and 3GPP Long Term Evolution (LTE) protocols.

Typically, a national government will grant permission to multiple mobile network operators to manage cellular networks in its territory. Each mobile network operator will be allowed to use certain radio frequencies for its operations, and it will not be permitted for an unlicensed operator to use those radio frequencies. A mobile network operator is typically interested in improving its ability to provide network coverage throughout the territory in which it is licensed.

In order for a cellular phone to be used in a particular territory, it must be able to operate using the cellular communications protocol of the network that has been licensed in that territory, and it must also be able to operate at the radio frequencies allocated to the relevant mobile network operator.

It is common for cellular phones to be able to operate under multiple cellular communications protocols, and in multiple radio frequency bands. Thus, even when a subscriber travels outside his home territory, the subscriber's mobile phone is able to establish a connection with a cellular network in the visited territory, and hence into the public telephone system. However, mobile network operators often levy higher call charges for such calls than for calls made within the subscriber's home territory.

According to a first aspect of the present invention, there is provided a wireless access device, comprising:
a first interface for establishing a connection with a mobile device using a cellular communications protocol at a maximum range of 1 metre; and
a second interface for establishing a connection with a cellular network over a public wide area network.

This has the advantage that the user of the mobile device is effectively able to establish a cell of his home network, wherever he may be, allowing him to use his mobile device as if he were in the territory of his home network. This may have the effect of reducing the cost of calls and/or providing access to a wider range of services than would be available in a different network.

For a better understanding of the present invention, and to show how it may be put into effect, reference will now be made, by way of example, to the accompanying drawings, in which:—

FIG. 1 illustrates a first system, including a wireless access device;

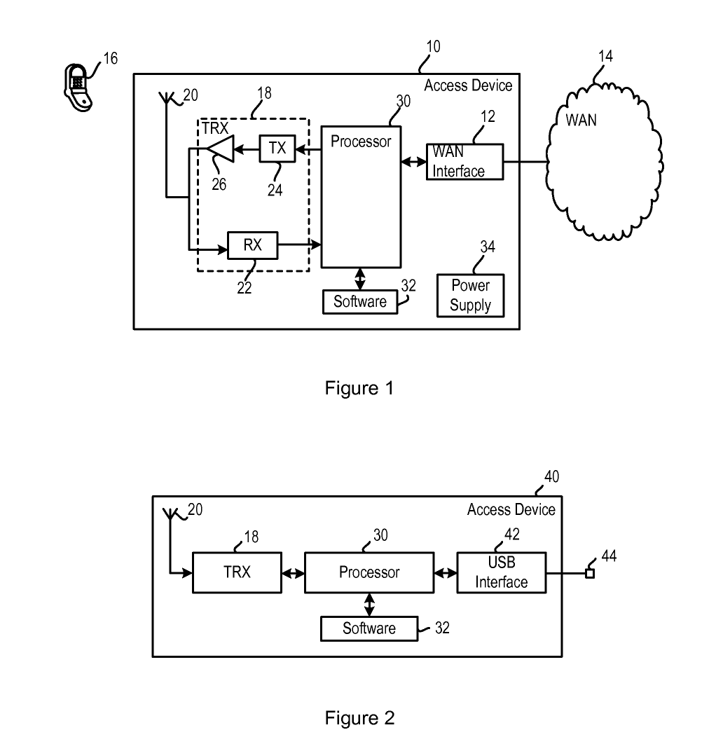

FIG. 2 is a schematic diagram showing a first alternative form of wireless access device;

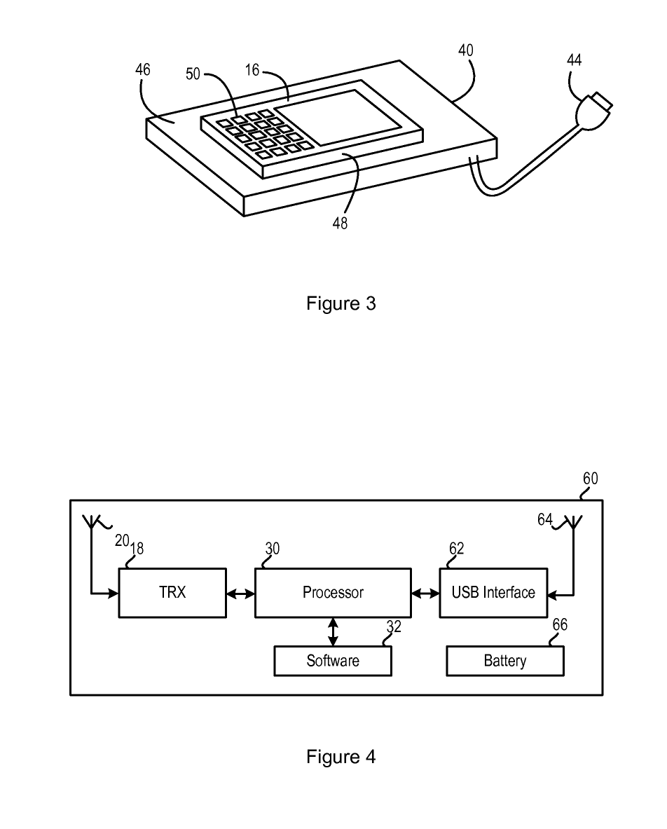

FIG. 3 illustrates the wireless access device of FIG. 2, in use;

FIG. 4 is a schematic diagram showing a second alternative form of wireless access device;

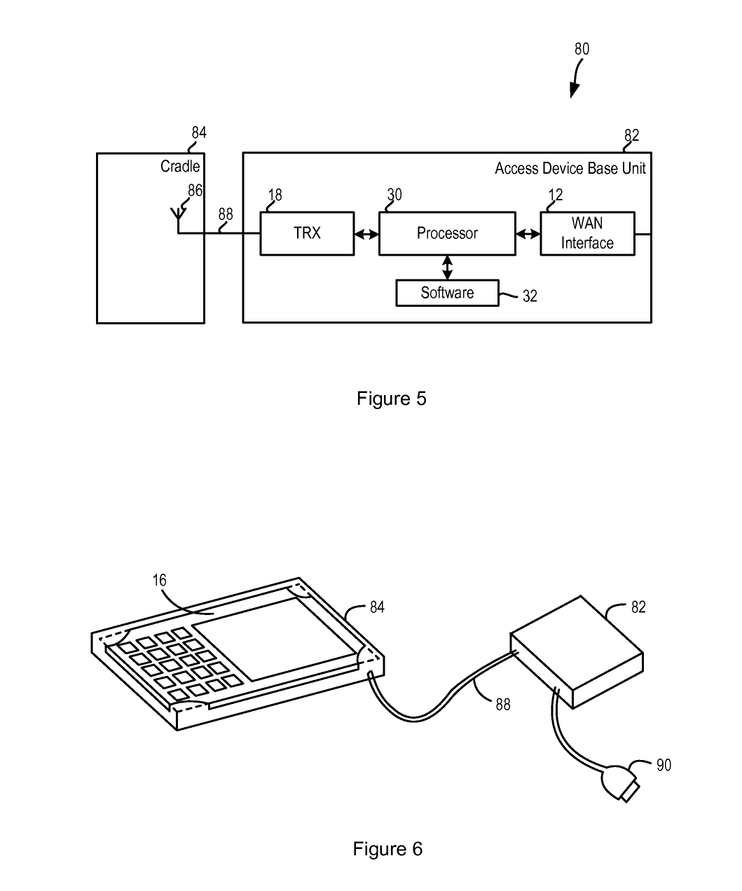

FIG. 5 is a schematic diagram showing a third alternative form of wireless access device;

FIG. 6 illustrates the wireless access device of FIG. 5, in use; and

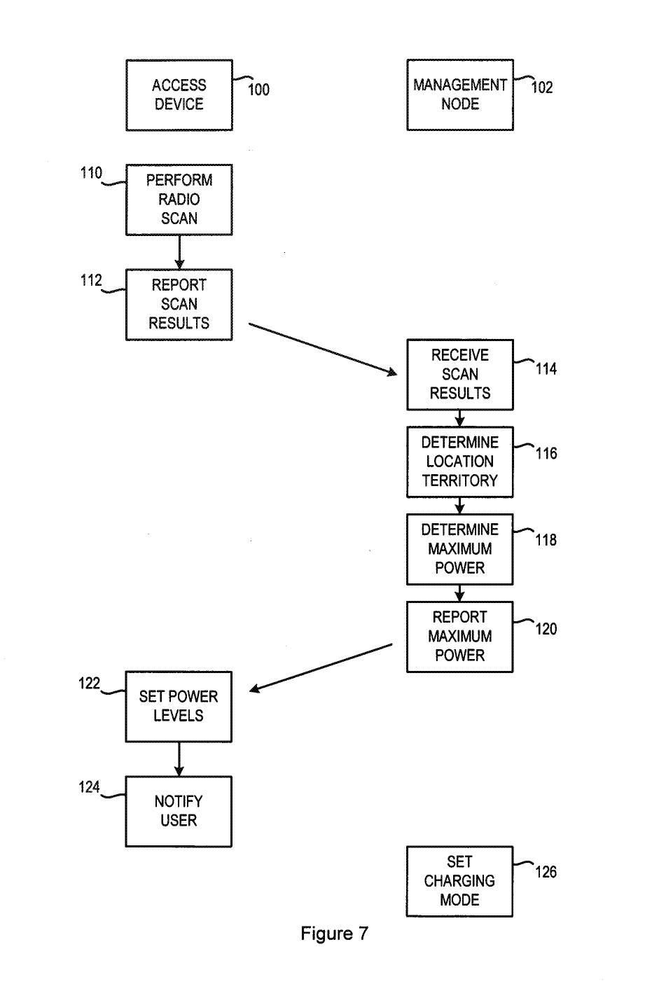

FIG. 7 is a flow chart, illustrating a process performed between a wireless access device and a management node of a cellular communication network.

FIG. 1 is a schematic illustration of a part of a telecommunications network, showing the use of a wireless access device 10 in accordance with the present invention. The access device 10 has a large part of the functionality of a femtocell base station. This functionality is well known, and will not be described in further detail here, except to the extent that this is necessary for an understanding of the present invention.

As is known in a femtocell base station, the access device 10 has an interface 12 for access to a wide area network 14, such as the internet. This allows the access device 10 to establish a connection over the wide area network 14 into the core network of a cellular mobile network. In order that the core network allows such access, the access device 10 is provided with suitable means for identification and authentication, for example in the form of a Subscriber Identity Module (SIM), either in the form of a SIM card or in software.

In addition, the access device 10 has an interface for establishing a connection to a cellular device 16, which may take the form of a mobile phone, a smartphone, a netbook, an e-reader, a handheld communicator, or the like. The cellular device 16 is provided with suitable means for identification and authentication, for example in the form of a SIM card, provided by the operator of the cellular network into which the access device 10 connects.

The access device 10 has transceiver circuitry (TRX) 18 and an antenna 20 for connection with the cellular device 16. As is generally conventional, the transceiver circuitry 18 includes receiver circuitry (RX) 22, for receiving incoming signals from the antenna 20. The transceiver circuitry 22 also includes transmit circuitry (TX) 24, for receiving signals for transmission, and converting them into signals that are modulated onto a suitable radio frequency signal for transmission, and a power amplifier 26, for amplifying the signals to a level at which they can be transmitted via the antenna 20.

The access device 10 operates under the control of a processor 30, having suitable operating software 32. The access device 10 also has a power supply 34.

It is known that cellular communications networks typically operate using licensed radio frequencies. That is, governments grant specific permissions to mobile network operators, and their subscribers, to transmit radio signals within specific frequency bands. It is then typically illegal for any unlicensed person to broadcast signals within the licensed frequency bands, in order to avoid the possibility of interference with the signals transmitted by the licensed mobile network operators. However, the present invention proceeds from the fact that it is typically not illegal to transmit signals within the licensed frequency bands, provided that the signals are of sufficiently low power that they do not interfere with licensed users.

Thus, the transceiver circuitry 18 is designed and controlled such that the power amplifier 26 is only able to transmit signals that ensure there is no interference with licensed users. For example, the transmit power might be limited to a maximum of 1 mW. More generally, the transmit power of the access device 10 is set such that the mobile device 16 receives signals with an acceptable signal strength (i.e. sees full bars) with the mobile device coupled to, or in close proximity with, the access device 10, but such that the range supported is less than 1 m when uncoupled. With such a small range, the possibility of interference with licensed users is eliminated, and so the access device 10 can operate in the licensed frequency bands.

Similarly, the sensitivity of the receiver circuitry 22 is optimised such that the access device operates at the lowest transmit power possible within its transmit dynamic range. This will mean that the access device 10 will typically only be able to receive signals transmitted from a range of 1 metre or so.

Thus, provided that the user stays within the operating range of the access device 10, he can use his mobile device 16 in the normal way. That is, the access device 10 will establish a connection over the wide area network 14 into the user's home cellular network, based on the SIM or other identifier provided in the access device 10. This process is the same as that followed by a conventional femtocell basestation. This allows the access device 10 to act as a basestation within that home cellular network, even though the cell might have a radius of less than 1 metre. This can occur wherever the user of the access device 10 is able to establish an acceptable internet connection, regardless of the user's geographical location relative to the region in which the user's home cellular network is licensed.

Then, when the mobile device 16 is switched on, it will first attempt to establish a connection to the user's home network, based on the identity indicated by the SIM card provided by the operator of that network, which is in the mobile device. Provided that the mobile device 16 is close enough to the access device 10 to be within this small cell, it will successfully establish a connection to the home cellular network, and the user will thereafter be able to use the mobile device as normal, with data being passed over the home cellular network in the normal way.

The operating software 32 of the access device 10 provides all of the functionality of a femtocell basestation, with certain changes.

Firstly, the access device 10 takes the form of a cellular basestation that is only intended to have a single user connected to it. This means that the allocation of power to pilot and traffic channels can be optimised to reduce the overall total transmit power whilst providing a full service to that single user.

Secondly, the maximum allowable transmit power from the mobile device 16 can be set at a fairly narrow range (say 10 dB) at the bottom of the dynamic range, in order to minimise the transmit power and thus interference to networks.

Thirdly, the access device 10 can be provided with presence detection software such that, with a suitable application on the mobile device 16, certain content can be downloaded automatically, taking advantage of the fact that the mobile device is temporarily connected to its home network.

In this case, the transceiver circuitry (TRX) 18 and antenna 20 are such that the cellular interface has a range of only 10-20 millimetres, meaning that the mobile device 16 needs to be extremely close to, or in contact with, the access device 40 in order to establish a connection thereto.

FIG. 2 shows one specific form of access device 40. The access device 40 is generally similar to the access device 10 shown in FIG. 1, in that it has transceiver circuitry (TRX) 18 connected to an antenna 20, operating under the control of a processor 30 and operating software 32.

In FIG. 2, the wide area network interface is in the form of a USB interface 42, connected to a USB connector 44. This allows the access device 40 to be connected to any device, such as a personal computer (PC), laptop computer, or the like, that has at least one USB socket and is itself able to connect to the internet. For example, it is common for personal computers to have network connections that allow them to connect to the internet. When the access device 40 plugs into a networked PC, it is then able to use this network connection to connect over the internet. Similarly, it is common for laptop computers to have Wi-Fi connectivity, allowing them to connect to the internet when they are in range of a Wi-Fi access point. When the access point 40 is plugged into such a laptop computer, it is able to use the Wi-Fi connection to establish its own connection over the internet.

When the access device has a USB connector, as shown in FIG. 2, it is advantageous for the access device also to obtain its power by means of the USB connector, from the device into which the access device is connected. The low operating power of the power amplifier in the transceiver circuitry 18 makes this possible.

When the access device 40 has established an internet connection, it analyses its IP address. From its IP address, the access device 40 is able to determine the country in which it is located. Alternatively, or additionally, the access device monitors transmissions from cellular base stations, and detects the mobile country code (MCC) components of the Public Land Mobile Network-Identifiers (PLMN-IDs) on the broadcast channels (BCH) of the transmissions that it is able to detect. Again, the access device 40 is able to use these to determine which country it is in.

Knowing the country in which it is located, the access device 40 will be able to determine the maximum power that is legally permitted for transmissions in the frequency band(s) licensed for cellular networks. The access device then sets its radio power to a level that is below this licensed level. If the legal situation in that country is that deliberate transmission on a licensed frequency is always prohibited, and there is no power at which transmission is acceptable, the access device can shut down, with appropriate notification to the user.

In some countries the allowable power will be high enough to allow a cellular phone to receive signals from the access device 40, provided that it remains in the same room. In that case, the access device 40 can act as a typical femtocell. In other countries, the maximum permitted transmit power will be such that the range of the access device will be extremely small, for example just 5 mm.

FIG. 3 shows the access device 40 in use, in the situation where its maximum transmit power is restricted such that the device has a range of only a few millimetres. As described above, the access device 40 has a USB connector that allows it to be connected to any suitable device that has a USB socket and can connect to the internet, such as a PC or laptop computer.

It will be seen that the access device 40 is of a size and shape such that it has a flat upper surface 46, on which the mobile device 16 can be placed. This allows the mobile device, in this case in the form of a smartphone 48, to establish a connection using the cellular communications interface, for as long as the smartphone 48 remains on the surface 46 of the access device 40. Thus, the user is able to use the smartphone 48 in this position for data access, requiring the use of the keypad 50 on the smartphone. If the user wishes to use the mobile device for a voice call, it is possible to establish a connection between the mobile device and a headset, using the Bluetooth short range wireless protocol, for example.

The upper surface can be provided with switches (for example contact switches or magnetic switches) that prevent the access device 40 from transmitting, unless the mobile device 16 is in contact with the upper surface 46. This provides a further assurance that the access device will not transmit at a power that causes any interference, and also ensures that power usage is minimised when the mobile device is not present.

FIG. 3 shows an access device 40 that is a separate device. However, the access device 40 can also be built into, or combined with, another device having a wide area network interface, such as a router, or the like. The access device circuitry can then be included in the router casing, with the antenna 20 located close to a surface of the router, and with the router casing being shaped such that a mobile device 16 can be laid on that surface of the router so that it is sufficiently close to the antenna 20.

FIG. 4 shows an alternative specific form of access device 60. The access device 60 is generally similar to the access device 10 shown in FIG. 1, in that it has transceiver circuitry (TRX) 18 connected to an antenna 20, operating under the control of a processor 30 and operating software 32.

In this case, the transceiver circuitry (TRX) 18 and antenna 20 are such that the cellular interface has a range of only 10-20 millimetres, meaning that the mobile device 16 needs to be extremely close to, or in contact with, the access device 60 in order to establish a connection thereto. Specifically, the access device 60 may be of a size and shape such that it has a flat upper surface, on which a mobile device 16 can be placed, in order to ensure that the mobile device 16 remains within range of the access device 60, as described above with reference to FIG. 3.

In FIG. 4, the wide area network interface is in the form of a Wi-Fi interface 62, containing suitable Wi-Fi interface circuitry, connected to an antenna 64. This allows the access device 60 to be connected to any device, such as a laptop computer, or the like, that itself has Wi-Fi capability and is able to connect to the internet when it is in range of a Wi-Fi access point. When the access point 60 is connected to such a laptop computer, it is able to use the Wi-Fi connection to establish its own connection over the internet.

The access device 60 has a battery 66 as its power source, although it could of course alternatively or additionally have a mains power connector.

As a further alternative to the USB interface 42 shown in FIG. 2 and the Wi-Fi interface 62 shown in FIG. 4, the WAN interface can take the form of an Ethernet connection, allowing the access device to be plugged into any network socket.

FIG. 4 shows an access device 60 that is a separate device. However, the access device 60 can also be built into, or combined with, another device having a Wi-Fi interface, such as a portable computer, or the like. The Wi-Fi interface 62 can then be shared with the Wi-Fi interface that the portable computer uses for wireless internet access, and the access device circuitry can be included in the PC casing, with the antenna 20 located close to a surface of the PC. The PC can be shaped such that a mobile device 16 can be laid on that surface of the router so that it is sufficiently close to the antenna 20. For example, the antenna 20 can be located in the PC such that the mobile device 16 is within a few centimetres of the antenna when it is lain on the closed lid of the portable computer, or on the screen or on the keyboard of the portable computer when it is open.

FIG. 5 shows a further alternative specific form of access device 80, including an access device base unit 82 and a cradle 84. In this case, the access device base unit 82 contains transceiver circuitry (TRX) 18, operating under the control of a processor 30 and operating software 32. In addition, the access device base unit 82 includes the wide area network interface 12, which may be of any convenient form, for example a USB connection as described with reference to FIG. 2 or a Wi-Fi connection as described with reference to FIG. 4.

As shown in FIG. 5, the antenna 86 is located separately from the transceiver circuitry 18, and is connected thereto by means of a wire 88, which extends between the base unit 82 and the cradle 84.

The cradle 84 is such that it can be used to contain the mobile device 16, without altering its operation in any way. Since the mobile device is intended to be used when inside the cradle 84 in this example, it is only necessary for the antenna 86 to have a range of 10-20 millimetres.

FIG. 6 shows the access device 80 in use. In this illustrated example, the access device base unit 82 has a USB connector 90 that allows it to be connected to any suitable device that has a USB socket and can connect to the internet, such as a PC or laptop computer.

The cradle 84 is connected to the base unit 82 by means of a wire 88, which is long enough (for example 1-2 metres) to allow the user some mobility when using the mobile device 16.

As the power consumption of the access device 80 is so low, it can be powered through the USB connector 90 from the device into which the USB connector is plugged. In addition, a bias tee circuit allows power to be injected on the RF cable 88, allowing the mobile device 16 to be charged from the cradle 84. Thus, the user is able to charge the mobile device 16 by insertion in the cradle 84, and this also provides access to the home cellular network.

The cradle 84 can for example be made of a thin material, perhaps in two layers with the antenna 86 sandwiched between the layers over at least a part of their area, such that it can hold the mobile device 16 and ensure that the mobile device 16 remains in close proximity to the antenna 86. At the same time, the cradle 84 does not obstruct any of the normal functions of the mobile device 16. For these reasons, it is advantageous for the cradle to be of a size and shape that is specific to the model of mobile device being used.

FIG. 7 is a flow chart, illustrating a method performed between an access device 100 and a management node 102 in the network of a cellular mobile communication network.

The access device 100 in this case can be similar to the access device 10 shown in FIG. 1, the access device 40 shown in FIG. 2, the access device 60 shown in FIG. 4, or the access device 80 shown in FIG. 4, for example. The access device 100 might for example be supplied to a consumer by an operator of a cellular mobile communications network in one particular territory, and the consumer will typically obtain a mobile phone or other cellular communications device from the same network operator.

In step 110 of the method, the access device 100 performs a radio scan. That is, the access device 100 is able to tune its receive circuitry across the frequency bands in which the system downlink frequencies of the cellular system might occur, and it uses this capability to monitor transmissions from nearby cellular base stations. Specifically, the access device 100 is able to detect information such as the mobile country code (MCC) components of the Public Land Mobile Network-Identifiers (PLMN-IDs) on the broadcast channels (BCH) of the transmissions that it is able to detect.

As mentioned above, the access device 100 could in principle use this information itself to determine which country it is in. However, in step 112 of the process shown in FIG. 7, the access device 100 reports the results of the radio scan.

For example, the access device 100 can extract the mobile country code (MCC) components mentioned above, and report these. Specifically, in this illustrated process, the access device 100 reports the results to a management node 102 of the cellular network operated by the supplier of the access device 100.

As discussed above with reference to FIG. 1, the access device 100 is able to establish a connection over the wide area network 14 into the core network of the cellular mobile network, and is thus able to send the report to the relevant management node 102. In an alternative, when the access device 100 is unable to detect any transmissions from nearby cellular basestations, it can report the IP address to which it is located.

In step 114, the management node receives the report from the access device 100. In step 116, the management node determines from the report the territory in which the access device 100 is located. Where the report includes mobile country code components of broadcasts from nearby cellular basestations, the management node can simply determine the territory represented by these components. Where the report includes an IP address, at which the access device 100 is located, the management node is able to look up a territory in which that IP address is located.

In step 118, the management node 102 determines the relevant legal restrictions on transmitting signals. Specifically, each country has the ability to set a maximum power that is legally permitted for transmissions in the frequency band(s) licensed for cellular networks. Having determined the territory in which the access device 100 is located in step 116, the management node 102 is able to determine this maximum power, from example from a database. The legal restrictions might be such that deliberate transmission on the licensed frequency is always prohibited, in which case usage of the access device 100 will not be permitted.

In step 120, the management node 102 sends a message to the access device 100, informing it of this maximum power, or that usage of the access device is not permitted. This message can also indicate the transmit and receive frequencies that the access device 100 should use, in the case when usage is permitted. For example, these frequencies might be the frequencies used in that territory by a network operator that has an established relationship with the network operator that has supplied the access device 100.

In step 122, the access device 100 receives the message from the management node 102, and then sets its radio power to a level that is below the licensed level that applies in its current location, and ensures that any connected mobile phone also transmits signals at power levels below the licensed level. Alternatively, the access device 100 shuts down if its use is not permitted.

In some countries the allowable power will be high enough to allow a cellular phone to receive signals from the access device 100, provided that it remains in the same room. In that case, the access device 100 can act as a typical femtocell. In other countries, the maximum permitted transmit power will be such that the range of the access device will be extremely small, for example just 5 mm.

In step 124, the access device 100 informs the user whether it can be used and, if so, of the mode in which it can be used, that is, whether it can act as a typical femtocell, or whether its maximum permitted transmit power is such that the user's handheld device must be kept within a very short distance of the access device. For example, this notification can be sent by sending an SMS message to the handheld device, causing a home page displayed on the handheld device to carry an appropriate message, or displaying an appropriate indicator (for example in the form of an LED) on the access device 100 itself.

Based on this, the user will know whether he is able to use his handheld device in a relatively conventional manner, for example at any position in a room in which the access device 100 is located, or whether the handheld device must be constrained to operate within the very short distance of the access device, for example as shown in FIG. 3 or FIG. 6.

In step 126 of the process shown in FIG. 7, the management node 102 sets an appropriate charging node, so that usage of the access device 100 can be billed to the user's existing account.

There is thus provided a wireless access device that allows a user to use his existing mobile communications device to access his home cellular communications network from a wide range of locations.

1. A wireless access device, comprising:
a first interface for establishing a connection with a mobile device using a cellular communications protocol at a maximum range of 1 metre; and
a second interface for establishing a connection with a cellular network over a public wide area network.

2. A wireless access device as claimed in claim 1, wherein the second interface comprises a USB connector.

3. A wireless access device as claimed in claim 1, wherein the second interface comprises a Wi-Fi interface.

4. A wireless access device as claimed in claim 1, wherein the second interface comprises an Ethernet connector.

5. A wireless access device as claimed in one of claims 1 to 4, having a surface on which the mobile device can be placed in order to establish the connection therewith.

6. A wireless access device as claimed in claim 5, comprising at least one switch, for controlling operation of the device depending on whether the mobile device is present on the surface.

7. A wireless access device as claimed in claim 6, wherein the wireless access device transmits cellular signals only when the mobile device is detected on the surface.

8. A wireless access device as claimed in one of claims 1 to 4, comprising a base unit and a cradle in which the mobile device can be placed in order to establish the connection therewith.

9. A wireless access device as claimed in claim 8, wherein the cradle comprises an antenna for establishing the connection with the mobile device.

10. A wireless access device as claimed in claim 8, comprising a wired connection between the base unit and the cradle.

11. A wireless access device as claimed in claim 8, comprising means for charging a mobile device placed in the cradle.

12. A wireless access device, comprising:
a first interface for establishing a connection with a mobile device using a cellular communications protocol; and
a second interface for establishing a connection with a cellular network over a public wide area network;
wherein the wireless access device is adapted to:
send a report containing location indicative information to a management node of a network;
receive a reply from the management node; and
set at least one of a transmit power of the device and a transmit power of a mobile device having a connection thereto, based on said reply,
wherein in one mode of operation the transmit power of the device or the transmit power of the mobile device having a connection thereto are such as to allow a maximum range of 1 metre.

13. A wireless access device as claimed in claim 12, wherein the second interface comprises a USB connector.

14. A wireless access device as claimed in claim 12, wherein the second interface comprises a Wi-Fi interface.

15. A wireless access device as claimed in claim 12, wherein the second interface comprises an Ethernet connector.

16. A wireless access device as claimed in one of claims 12 to 15, having a surface on which the mobile device can be placed in order to establish the connection therewith.

17. A wireless access device as claimed in claim 16, comprising at least one switch, for controlling operation of the device depending on whether the mobile device is present on the surface.

18. A wireless access device as claimed in claim 17, wherein the wireless access device transmits cellular signals only when the mobile device is detected on the surface.

19. A wireless access device as claimed in one of claims 12 to 15, comprising a base unit and a cradle in which the mobile device can be placed in order to establish the connection therewith.

20. A wireless access device as claimed in claim 19, wherein the cradle comprises an antenna for establishing the connection with the mobile device.

21. A wireless access device as claimed in claim 19 or 20, comprising a wired connection between the base unit and the cradle.

22. A wireless access device as claimed in claim 12, wherein in a second mode of operation the transmit power of the device or the transmit power of the mobile device having a connection thereto are such as to allow a range of more than 1 metre.

23. A wireless access device as claimed in claim 22, comprising an indicator for indicating whether the wireless access device is operating in the first or second mode of operation.

24. A wireless access device as claimed in claim 12, wherein the location indicative information comprises information derived from transmissions by nearby cellular basestations.

25. A wireless access device, comprising a femtocell basestation, having means for connection over a public wide area network, and that is restricted such that it transmits signals at licensed frequencies at a power sufficiently low to avoid interference with licensed users.

26. A wireless access device, comprising a femtocell basestation operable in a cellular network using licensed frequencies, the femtocell basestation having an interface for establishing a wired or wireless connection over a public wide area network into the cellular network even when the femtocell basestation is located outside a coverage area of the cellular network, and the femtocell basestation being restricted such that it transmits signals at a power sufficiently low to avoid interference with licensed users at its location.

27. A method of operation of a wireless access device, the method comprising:
obtaining location indicative information;
sending a report containing the location indicative information to a management node of a network;
receiving a reply from the management node; and
setting at least one of a transmit power of the device and a transmit power of a mobile device having a connection thereto, based on said reply,
wherein in one mode of operation the transmit power of the device or the transmit power of a mobile device having a connection thereto are such as to allow a maximum range of 1 metre.

28. A method as claimed in claim 27, wherein the location indicative information comprises information derived from transmissions by nearby cellular basestations.

29. A method as claimed in claim 27, comprising:
attempting to detect transmissions by nearby cellular basestations;
if transmissions by nearby cellular basestations can be detected, extracting the location indicative information from said transmissions; and
if transmissions by nearby cellular basestations can not be detected, sending a report containing an IP address to which the wireless access device is connected as the location indicative information.

30. A method as claimed in claim 27, comprising:
indicating to a user whether the wireless access device is operating in the one mode of operation in which the transmit power or the receive power are such as to allow a maximum range of 1 metre, or whether the wireless access device is operating in another mode of operation in which the transmit powers are such as to allow a maximum range of greater than 1 metre.
